(19) United States
(12) Patent Application Publication
(10) Pub. No.: US 2024/0272329 A1
(43) Pub. Date: Aug. 15, 2024

(54) OPTICAL ELEMENT WITH EXCELLENT ENVIRONMENTAL DURABILITY

(71) Applicant: CANON KABUSHIKI KAISHA, Tokyo (JP)

(72) Inventor: MAMO MATSUMOTO, Kanagawa (JP)

(21) Appl. No.: 18/435,801

(22) Filed: Feb. 7, 2024

(30) Foreign Application Priority Data
Feb. 10, 2023 (JP) 2023-019074

(51) Int. Cl. G02B 1/04; G02B 3/02; G02B 7/02

(52) U.S. Cl. CPC G02B 1/041; G02B 3/02; G02B 7/021

(57) ABSTRACT

An optical element includes: a base material; and a resin portion, wherein the base material has a spherical surface, a flat surface surrounding the spherical surface, and a ridge line portion including a ridge line at the boundary between the spherical surface and the flat surface, wherein the resin portion is provided over the spherical surface and over the flat surface straddling the ridge line portion, has a linear expansion coefficient different from a linear expansion coefficient of the base material, has a maximum thickness at a first point between a center and an edge of the spherical surface of the base material, which is thicker than a thickness at the center, has a thickness thinner than the maximum thickness at a second point between the first point and the edge, and has a thickness thicker at the ridge line portion than the thickness at the second point.

### BACKGROUND

### Field of the Disclosure

The present disclosure relates to an optical element.

### Description of the Related Art

As one of optical elements, a lens in which a cured material of a resin composition is provided on a transparent base material such as glass is known. Such a lens is manufactured by using a mold and polymerizing or copolymerizing a resin composition between the base material and the mold to form the cured material of a desired shape on the surface of the base material. Lenses manufactured by such a manufacturing method are called replica elements. Since the replica elements can easily be formed in desired surface shapes, the replica elements are effective to be used as aspherical lenses or Fresnel lenses. An aspherical lens is a general term for a lens whose curvature varies continuously from the lens center to the periphery. Japanese Patent Application Laid-Open No. H07-72310 and Japanese Patent Application Laid-Open No. 2009-192754 disclose aspherical lenses, in each of which an aspherical resin portion is molded on a base material, as examples of the replica elements.

However, while the optical elements disclosed in Japanese Patent Application Laid-Open No. H07-72310 and Japanese Patent Application Laid-Open No. 2009-192754 have excellent optical characteristics, when the optical elements are used in a low temperature environment, cracks in the resin may occur due to the generation of a large thermal stress on the outer peripheral portion of the lenses, and there may be an issue with the environmental durability of the lenses.

### SUMMARY OF THE DISCLOSURE

It is an object of the present disclosure to provide an optical element having both excellent optical characteristics and excellent environmental durability, and a method for manufacturing the optical element.

According to one aspect of the present disclosure, there is provided an optical element including: a base material; and a resin portion, wherein the base material has a spherical surface, a flat surface surrounding the spherical surface, and a ridge line portion including a ridge line at the boundary between the spherical surface and the flat surface, wherein the resin portion is provided over the spherical surface and over the flat surface of the base material straddling the ridge line portion, has a linear expansion coefficient different from a linear expansion coefficient of the base material, has a maximum thickness at a first point between a center and an edge of the spherical surface of the base material, which is thicker than a thickness at the center, has a thickness thinner than the maximum thickness at a second point between the first point and the edge, and has a thickness thicker at the ridge line portion than the thickness at the second point.

Further features of the present disclosure will become apparent from the following description of exemplary embodiments with reference to the attached drawings.

### BRIEF DESCRIPTION OF THE DRAWINGS

FIG. 1A, FIG. 1B and FIG. 1C are schematic diagrams illustrating an optical element according to a first embodiment of the present disclosure.

FIG. 2A and FIG. 2B are schematic diagrams illustrating a method of manufacturing an optical element according to the first embodiment of the present disclosure.

FIG. 3 is a schematic diagram illustrating an imaging apparatus according to a second embodiment of the present disclosure.

### DESCRIPTION OF THE EMBODIMENTS

### First Embodiment

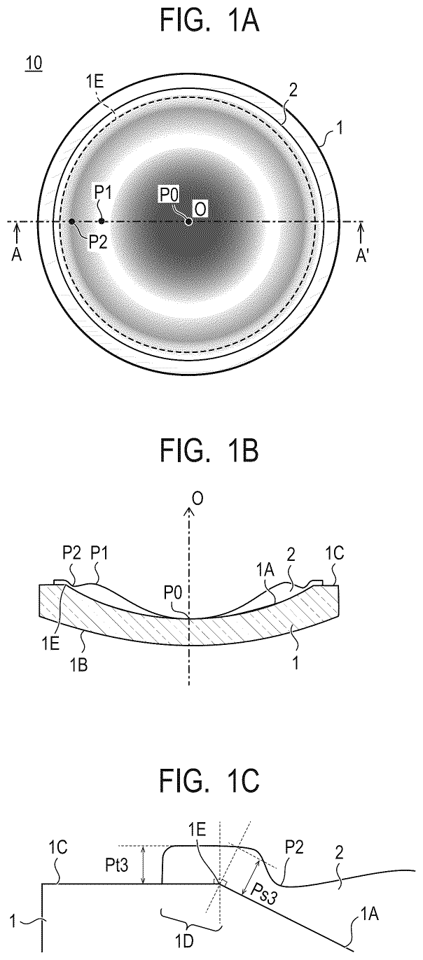

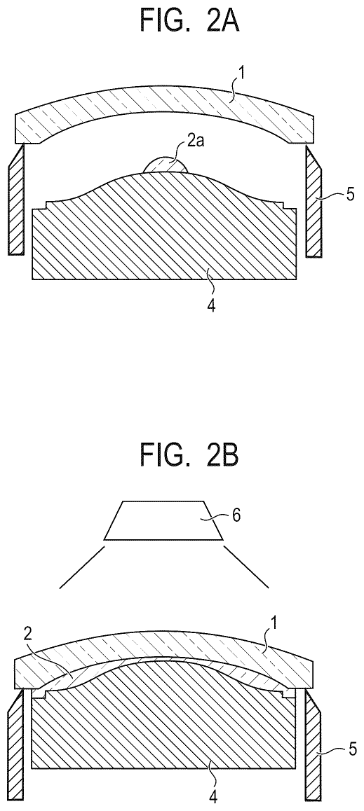

An optical element and a manufacturing method of an optical element according to a first embodiment of the present disclosure will be described with reference to FIG. 1A to FIG. 2B.

First, a configuration of the optical element according to the present embodiment will be described with reference to FIG. 1A to FIG. 1C. FIG. 1A to FIG. 1C are schematic diagrams illustrating a configuration of the optical element 10 according to the present embodiment. FIG. 1A is a plan view illustrating the optical element 10. FIG. 1B is a cross-sectional view along line A-A′ in FIG. 1A in the thickness direction. FIG. 1C is a cross-sectional view illustrating an enlarged portion of the optical element 10.

The optical element 10 according to the present embodiment is a type of an optical element called a replica lens. As illustrated in FIG. 1A to FIG. 1C, the optical element 10 according to the present embodiment includes a transparent base material 1 and a resin portion 2 which is a cured resin formed on the base material 1. The resin portion 2 is formed on the spherical surface of the base material 1 in close contact with each other. The thickness of the resin portion 2 is not uniform in the element radial direction and has a non-uniform distribution in the plane. As a result, the surface of the resin portion 2 has an aspherical surface shape.

The base material 1 has a first surface 1A and a second surface 1B, which are optical surfaces, and a flat surface 1C. The first surface 1A is one of a light incident surface and a light emitting surface, and the second surface 1B is the other of the light incident surface and the light emitting surface. The first surface 1A is a concave spherical surface. The second surface 1B is a convex spherical surface. The flat surface 1C is formed to surround the first surface 1A via a ridge line 1E and to connect to the first surface 1A. A portion outside a second point P2 of the first surface 1A and an inner portion of the flat surface 1C form a ridge line portion 1D including the ridge line 1E. The resin portion 2 having a non-uniform distribution in thickness is continuously provided on the entire surface of the first surface 1A and on the flat surface 1C, crossing the ridge line portion 1D.

The thickness of the resin portion 2 having the aspherical surface shape has the maximum thickness at a first point P1 located between the lens center P0 which is the center of the first surface 1A which is the spherical surface and an edge portion, wherein the maximum thickness is thicker than the thickness at the lens center P0. Here, the film thickness of the resin portion 2 refers to the thickness in the normal direction with respect to the first surface 1A which is the spherical surface of the base material 1. Since the resin portion 2 is molded in such a shape, the optical element 10 which is a replica lens is constituted as an aspherical lens having an aspherical shape. Furthermore, in the optical element 10 according to the present embodiment, the thickness of the resin portion 2 at a second point P2 between the first point P1 and the edge of the first surface 1A is thinner than the maximum thickness of the resin portion 2 at the first point P1.

Since the optical element 10 according to the present embodiment is constituted as an aspherical lens by using the resin portion 2, it can be manufactured with a high cycle compared with an aspherical lens constituted only of glass. Therefore, according to the present embodiment, an aspherical lens can be manufactured at a low cost.

In the optical element 10 according to the present embodiment, the resin portion 2 has the maximum thickness at the first point P1 that is thicker than the thickness at the lens center P0. Accordingly, the optical element 10 according to the present embodiment can achieve excellent optical characteristics. The thickness of the resin portion 2 at the first point P1 is preferably sufficiently thick relative to the thickness of the resin portion 2 at the lens center P0. Thus, the aspherical surface amount of the lens of the optical element 10 becomes larger, and the optical characteristics of the optical element 10 become superior. Specifically, from the viewpoint of improving the optical characteristics, it is preferable that the thickness of the resin portion 2 at the first point P1 is three times or more than the thickness of the resin portion 2 at the lens center P0. From the same viewpoint, it is more preferable that the thickness of the resin portion 2 at the first point P1 is thicker than the thickness of the resin portion 2 at the lens center P0 by 200 μm or more.

In an aspheric replica lens, thermal stress is generated in the outer peripheral portion of the lens due to an environmental change such as a temperature change in a temperature range of minus Celsius, for example, and the resin portion may crack due to the thermal stress. If the thickness of the resin portion is too thick, the thermal stress increases according to the thickness, and as a result, the probability of the resin portion cracking increases.

Therefore, the optical element 10 is characterized in that the resin portion 2 is molded so that the resin portion 2 has a thickness at the second point P2 located between the first point P1 and the edge in the optical element 10 that is thinner than the maximum thickness at the first point P1. Such a configuration has a certain effect in suppressing the thermal stress generated at the outer peripheral portion of the optical element 10 to a small extent. Specifically, the thickness of the resin portion 2 at the second point P2 is preferably equal to or less than 0.5 times the thickness of the resin portion 2 at the first point P1. Further, from the viewpoint of reducing the thermal stress generated in the outer peripheral portion of the optical element 10, the thickness of the resin portion 2 at the lens center P0 is preferably as thin as 300 μm or less. By making the resin portion 2 thin at the second point P2 and at the lens center P0 in this manner, the amount of warpage of the entire optical element 10 which is a lens can be reduced at the time of temperature change, and as a result, cracking of the resin portion 2 can be suppressed or prevented. Thus, the optical element 10 can have excellent environmental durability.

Regarding the generation of the thermal stress in the outer peripheral portion of an aspheric replica lens, in particular, the spherical portion and the outer peripheral portion of the lens are connected by a discontinuous surface through a ridge line, and the highest thermal stress generates in the resin on the ridge line when a temperature change occurs in the replica lens. Therefore, when the resin portion formed on the ridge line is thin, the thermal stress is concentrated in the thin resin portion, and resin cracking is likely to occur there.

Therefore, in the optical element 10 according to the present embodiment, the thickness of the resin portion 2 at the second point P2 is thinner than the thickness of the resin portion 2 at the first point P1, while the thickness of the resin portion 2 at the ridge line portion 1D located on the outer peripheral portion of the second point P2 is thicker than the thickness of the resin portion 2 at the second point P2. Thus, in the optical element 10 according to the present embodiment, the thermal stress generated in the resin portion 2 at the ridge line portion 1D can be dispersed in the thickness direction of the resin portion 2, thereby suppressing or preventing the cracking of the resin portion 2 when a temperature change occurs in the optical element 10. Specifically, the thickness of the resin portion 2 at the ridge line portion 1D is preferably 100 μm or more and more preferably 200 μm or more from the viewpoint of suppressing or preventing the cracking of the resin portion 2. Here, the thickness of the resin portion 2 at the ridge line portion 1D is the maximum value of the thickness of the resin portion 2 between the thickness Ps3 of the resin portion 2 in the normal direction of the first surface 1A, which is a lens spherical surface at the ridge line portion 1D illustrated in FIG. 1C, and the thickness Pt3 of the resin portion 2 in the normal direction of the flat surface 1C at the ridge line portion 1D. Although the position of the first point P1 is not particularly limited, it is preferable that the ratio of the distance P1-P0 from the center P0 to the first point P1 to the distance 1E-P0 from the center P0 to the ridge line 1E is 0.50 or more and 0.85 or less. More preferably, the ratio is 0.60 or more and 0.85 or less. Even more preferably, the ratio is 0.70 or more and 0.85 or less. Although the position of the second point P2 is not particularly limited, from the viewpoint of improving the optical characteristics, it is preferable that the ratio of the distance P2-P0 from the center P0 to the second point P2 to the distance 1E-P0 from the center P0 to the ridge line 1E is 0.80 or more and 1 or less. More preferably, the ratio is 0.90 or more and 1 or less. Even more preferably, the ratio is 0.95 or more and 1 or less.

As described above, the optical element 10 according to the present embodiment having a non-uniform distribution in the thickness of the resin portion 2 has excellent optical characteristics and excellent environmental durability. The optical element 10 according to the present embodiment can suppress the thermal stress in the ridge line portion 1D to a small degree even when used in a low temperature environment, and can suppress or prevent the cracking of the optical element 10.

As the base material 1, a material made of transparent resin or a material made of transparent glass can be used. In the present specification, transparent means that the transmittance of light in the wavelength range of 400 nm or more and 780 nm or less is 10% or more. The base material 1 is preferably made of glass, and specifically, the base material 1 can be made of common optical glass as typified by silicate glass, borosilicate glass, and phosphate glass, quartz glass, glass ceramics, or the like.

Note that the shape of the base material 1 is not particularly limited, while FIG. 1A to FIG. 1C illustrate a case where the first surface 1A is a concave spherical surface and the second surface 1B is a convex spherical surface. The shape of the first surface 1A, which is a surface of the base material 1 in contact with the resin portion 2, can be appropriately selected from a concave spherical surface, a convex spherical surface, an axisymmetric aspheric surface, a plane, or the like according to desired characteristics. Further, as illustrated in FIG. 1A, the base material 1 preferably has a circular planar shape when viewed in plan in a direction along the optical axis of the optical element 10 passing through the center of the first surface 1A, which is the lens center. With the base material 1 having a circular planar shape, the accuracy of assembling the optical element 10 can be improved when using the optical element 10 as a lens in the optical system as described later.

The flat surface 1C of the base material 1 is provided around the first surface 1A and is a flat surface arranged adjacent to the concave spherical first surface 1A. The base material 1 has a ridge line portion 1D at the boundary between the first surface 1A and the flat surface 1C. The ridge line portion 1D is a portion that includes the ridge line 1E at the boundary between the first surface 1A and the flat surface 1C. In the optical element 10 according to the present embodiment, the resin portion 2 is continuously molded on the first surface 1A and on the flat surface 1C in the base material 1 so as to straddle the ridge line portion 1D. In a manufacturing process of the optical element 10, variations may occur in the application amount of the resin composition applied for forming the resin portion 2. In the present embodiment, even if such variations in the application amount occur, the resin portion 2 is continuously molded across the ridge line portion 1D. Therefore, in the present embodiment, by setting the application amount of the resin composition to an application amount that is capable of forming the resin in the entire area of the first surface 1A, which is a spherical area, in advance, it is possible to prevent the occurrence of variation in the molding area of the resin portion 2 on the first surface 1A.

FIG. 1B illustrates a case where the flat surface 1C is a plane perpendicular to the layering direction of the resin portion 2 at the center O of the optical element 10, which is the center of the first surface 1A, but the flat surface 1C need not be a plane perpendicular to the layering direction. The flat surface 1C may be a plane deviating from a plane perpendicular to the layering direction of the resin portion 2 at the center O. It is preferable that the flat surface 1C has a surface roughness larger than that of the first surface 1A, which is a spherical surface, from the viewpoint of suppressing or preventing the resin of the resin portion 2 from peeling off from the base material 1 due to the generation of thermal stress when the temperature changes.

The resin portion 2 is closely formed on the first surface 1A and the ridge line portion 1D of the base material 1. The surface of the resin portion 2 has an aspherical surface shape. The resin portion 2 has a linear expansion coefficient different from that of the base material 1. The resin composition 2a (see FIG. 2A) for forming the resin portion 2 is a polymerizable composition and is preferably an energy curable composition suitable for molding using a mold. The energy curable composition is a composition containing a component which is polymerized and cured to become a resin by applying either one or both of light energy and thermal energy from an uncured state. Among the energy curable compositions, the resin composition 2a is more preferably an ultraviolet curable resin composition. For example, an acrylic resin or an epoxy resin can be used as the ultraviolet curable resin contained in the ultraviolet curable resin composition.

Since the resin portion 2, which is a cured product of the resin composition 2a, is made of an organic material, when it is combined with the base material 1 made of glass or the like, the base material 1 and the resin portion 2 have different linear expansion coefficients. Therefore, when a temperature change occurs in the optical element 10 as described above, thermal stress is generated mainly in the resin portion 2 in the ridge line portion 1D, but according to the present embodiment, the thermal stress can be dispersed as described above to suppress or prevent the cracking of the resin portion 2 due to the thermal stress.

The resin composition 2a for forming the resin portion 2 has a monomer raw material. Examples of the monomer raw material include acrylates such as methyl methacrylate, ethylene methacrylate, methyl acrylate, ethyl acrylate, butyl acrylate, and ethylene-based unsaturated monomers such as acrylic acid, styrene, butadiene, and divinyl benzene.

For the purpose of facilitating handling of the uncured resin, the monomer may be adjusted in advance to increase the molecular weight and thicken the uncured resin. The resin composition may also contain other organic or inorganic substances other than resin in order to adjust the optical and mechanical properties.

Further, the resin composition contains a polymerization initiator. The polymerization initiator may be a photo polymerization initiator or a thermal polymerization initiator and may be determined by the manufacturing process selected. However, in the case of performing replica molding for manufacturing the aspherical shape of the resin portion 2, the polymerization initiator is preferably a photo polymerization initiator from the viewpoint of fast curing speed. Commercially available photo polymerization initiators include, for example, 2-benzyl-2-dimethylamino-1-(4-morpholinophenyl)-1-butanone, 1-hydroxycyclohexylphenyl ketone, bis(2,4,6-trimethylbenzoyl)-phenylphosphine oxide, 4-phenylbenzophenone, 4-phenoxybenzophenone, 4,4′-diphenylbenzophenone, 4,4′-diphenoxybenzophenone, and 4,4′-diphenoxybenzophenone. The content of the photo polymerization initiator in the resin composition is preferably in the range of 0.01 mass % or more and 10 mass % or less. When the content of the photo polymerization initiator is less than 0.01 mass %, sufficient reactivity cannot be obtained, and when the content is more than 10 mass %, the transmittance of the cured resin portion 2 may decrease. An unreacted polymerization initiator remains in the cured resin portion 2.

The resin composition may contain a polymerization inhibitor, an oxidation inhibitor, a photostabilizer (HALS), an ultraviolet absorbent a silane coupling agent, a release agent, a pigment, a dye, and the like, as required.

The resin portion 2 is preferably highly transparent. Specifically, it is preferable that the resin portion 2 has an internal transmittance of 70% or more with respect to a wavelength of 400 nm at a converted thickness of 500 μm. The Abbe number of the resin portion 2 is preferably 50 or more and less than 60. Within this range, it is possible to accommodate various optical designs when the optical element 10 is used as a lens in an optical system.

Next, a manufacturing method of the optical element 10 according to the present embodiment will be described with reference to FIG. 2A and FIG. 2B. Although the manufacturing method of the optical element 10 according to the present embodiment is not particularly limited, an example of a suitable manufacturing method will be described below. FIG. 2A and FIG. 2B are schematic diagrams illustrating the manufacturing method of the optical element 10 according to the present embodiment. FIG. 2A and FIG. 2B illustrate a step of forming the resin portion 2 of the optical element 10 illustrated in FIG. 1A to FIG. 1C in cross sections along the layering direction of the resin portion 2.

First, the base material 1 and the resin composition 2a for forming the resin portion 2 are prepared (preparation step). Here, in order to improve the adhesion between the base material 1 and the resin portion 2, which is a cured product of the resin composition 2a, it is preferable that the first surface 1A of the base material 1 is pretreated, and it is more preferable that the first surface 1A and the flat surface 1C are pretreated, at least for the area where the resin portion 2 is to be formed. When the base material 1 is made of glass, for example, a silane coupling treatment, a corona discharge treatment, a UV ozone treatment, a plasma treatment, or the like can be selected as the pretreatment. In view of the fact that adhesion can be further enhanced by directly chemically bonding the surface on which the resin portion 2 is to be formed such as the first surface 1A and the resin portion 2, it is preferable to perform a coupling treatment using a silane coupling agent as the pretreatment. Specific silane coupling agents include, for example, 3-methacryloxypropyl methyl dimethoxysilane, 3-methacryloxypropyl trimethoxysilane, 8-methacryloxyoctyl trimethoxysilane, 3-acryloxypropyl trimethoxysilane, 3-methacryloxypropyl methyl diethoxysilane, and 3-methacryloxypropyl triethoxysilane.

Subsequently, as illustrated in FIG. 2A, the resin composition 2a is dropped onto the surface of a mold 4. As described above, the resin composition 2a is a composition of an ultraviolet curable resin containing a photo polymerization initiator, for example.

The base material 1 is then placed on an ejector 5 and arranged at a position facing the mold 4. The mold 4 has, for example, an inverted shape having a desired aspherical surface shape on the surface, and can be produced by cutting a metal base material such as stainless steel material or steel material subjected to NiP plating or oxygen free copper plating by a precision processing machine. A release agent may be applied to the surface of the mold 4 to control the release of the resin. The type of release agent is not particularly limited, but for example, a fluorine coating agent may be used as the release agent.

Subsequently, as illustrated in FIG. 2B, the ejector 5 is lowered so that the mold 4 approaches the base material 1, whereby the resin composition 2a is provided on the base material 1 (providing step). The ejector 5 is further lowered so that the uncured resin composition 2a is filled between the mold 4 and the base material 1 to be molded into a desired shape (molding step).

Subsequently, the resin composition 2a is polymerized and cured by irradiating the resin composition 2a between the base material 1 and the mold 4 with ultraviolet light from the side of the second surface 1B of the base material 1 using an ultraviolet light source 6. Thereby, the resin portion 2 which is a polymerized cured product of the resin composition 2a is obtained (light irradiation step and curing step).

Thereafter, the polymerized and cured resin portion 2 is released from the mold 4 to obtain the optical element 10 having the aspherical resin portion 2 formed on the base material 1. Note that, after the resin portion 2 is formed, additional irradiation of ultraviolet light or heat treatment may be performed in the air or in an anoxic atmosphere.

The optical element 10 according to the present embodiment can be manufactured by the above manufacturing method. In the providing step, the resin composition 2a may be dropped onto both the mold 4 and the base material 1 or dropped only onto the base material 1. When the resin composition 2a contains a heat polymerization initiator as a curing initiator, the light irradiation step may be changed to a heat treatment step. After the curing step, the base material 1 may be detached from the optical element 10, and only the resin portion 2 may be used as the optical element 10.

### Second Embodiment

The optical element 10 according to the first embodiment described above can be applied to a variety of equipment, apparatuses, and the like such as optical apparatuses, imaging apparatuses, and the like. In the present embodiment, an optical apparatus and an imaging apparatus will be described as specific application examples of the optical element 10 according to the first embodiment.

### (Optical Apparatus)

Specific application examples of the optical element 10 according to the first embodiment include a lens constituting an optical apparatus (imaging optical system) for a camera or video camera, a lens constituting an optical apparatus (projection optical system) for a liquid crystal projector, and the like. It can also be used for a pickup lens such as a DVD recorder. These optical systems include at least one lens arranged in the housing, and the optical element 10 according to the first embodiment can be used for the at least one lens.

### (Imaging Apparatus)

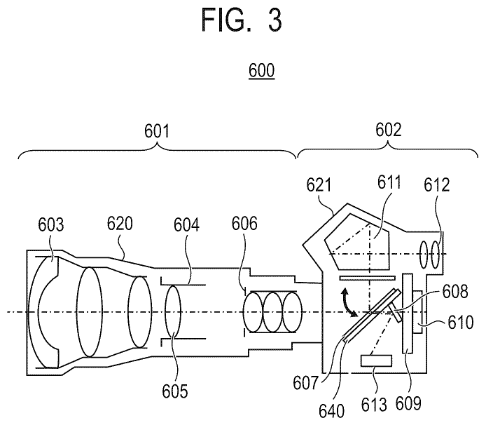

FIG. 3 is a schematic diagram illustrating a configuration of a single lens reflex digital camera 100, which is an example of a preferred embodiment of an imaging device using the optical element 10 according to the first embodiment. In FIG. 3, a camera body 602 and a lens barrel 601 which is an optical apparatus are coupled, and the lens barrel 601 is a so-called interchangeable lens which is attachable to and detachable from the camera body 602.

Light from a subject is photographed through an optical system including of a plurality of lenses 603, 605 and the like arranged on the optical axis of the photographing optical system in the housing 620 of the lens barrel 601. The optical element 10 according to the first embodiment can be used for the lenses 603 and 605, for example. Here, the lens 605 is supported by an inner cylinder 604 and movably supported with respect to the outer cylinder of the lens barrel 601 for focusing and zooming.

In the observation period before photographing, light from the subject is reflected by a main mirror 607 in the housing 621 of the camera body, transmitted through the prism 611, and the photographed image is projected to a photographer through a finder lens 612. The main mirror 607 is, for example, a half mirror, and the light transmitted through the main mirror 607 is reflected by a sub-mirror 608 in the direction of an AF (autofocus) unit 613, and the reflected light is, for example, used for distance measurement. The main mirror 607 is attached to and supported by a main mirror holder 640 by adhesion or the like. During photographing, the main mirror 607 and the sub-mirror 608 are moved out of the optical path through a driving mechanism (not illustrated), the shutter 609 is opened, and the imaging element 610 receives light entering from the lens barrel 601 and passing through the photographing optical system to form a photographed optical image. A diaphragm 606 is configured to change the brightness and the focal depth during photographing by changing the aperture area.

Note that, although the imaging apparatus has been described by using a single lens reflex digital camera, the optical element 10 can also be used for a smartphone, a compact digital camera, a drone, and the like in the same manner.

### EXAMPLES

Hereinafter, the present disclosure will be described in more detail with reference to examples. First, an evaluation method of the optical element 10 will be described. The evaluation of the optical element 10 was carried out on the thickness of the resin portion 2, the optical performance and the lens cracking.

### (Thickness of Resin Portion 2)

The optical element 10 was cut in the stacking direction of the resin portion 2 at a plane along the normal direction of the center O through the center O of the optical element 10 (plane passing through the optical axis center). A cross section of the cut optical element 10 was observed by a metal microscope (ECLIPSE ME600P by Nikon) at a magnification of 200 times.

With regard to the thickness of the resin portion 2, the thickness of the resin portion 2 in the normal direction of the spherical surface of the base material 1 was measured from the lens center P0 toward the ridge line portion 1D at a 10 μm pitch, and the first point P1 at which the thickness of the resin portion 2 became the maximum thickness was specified.

Subsequently, the thickness of the resin portion 2 in the normal direction of the spherical surface of the base material 1 was measured again from the first point P1 toward the ridge line portion 1D at a 10 μm pitch, and the second point P2 at which the thickness of the resin portion 2 became a local minimum value was specified. Subsequently, the maximum resin thickness between the thickness Ps3 and the thickness Pt3 of the resin portion 2 at the ridge line portion 1D was measured.

### (Optical Performance)

The obtained optical element 10 was used in the front group of the single-lens reflex digital camera to evaluate the imaging performance. At this time, in the resolution of the peripheral portion of the angle of view when the subject is focused at the center of the angle of view, the optical element 10 having a good resolving power was ranked as A, the optical element 10 having a resolving power at a level that does not hinder photographing was ranked as B, and the optical element 10 having a poor resolving power was ranked as C.

### (Lens Crack)

The obtained optical element 10 was put into a freezer maintained at a temperature environment of −40° C. from a room temperature state, the optical element 10 was taken out and returned to a room temperature of 25° C. after 24 hours, and then the appearance of the optical element 10 was evaluated. The optical element 10 without any crack of the resin portion 2 as a lens crack was ranked as “no crack”, and the optical element 10 with the resin crack was ranked as “with crack”.

### (Overall Evaluation)

The overall evaluation was ranked as A when the optical performance was A and the lens crack is “no crack”, B when the optical performance was B and the lens crack is “no crack”, and C when the optical performance was C and when the lens crack is “with crack” regardless of the rank of the optical performance.

Next, the optical elements 10 of Examples 1 to 9, which were evaluated in the respective ways described above, and the optical elements of Comparative Examples 1 to 3, which were evaluated in the same ways as the optical elements 10 of each example, will be described.

### Example 1

The optical element 10 illustrated in FIG. 1A to FIG. 1C was manufactured using the manufacturing method illustrated in FIG. 2A and FIG. 2B. As the base material 1, an optical glass (S-TIM8, made by Ohara) having a diameter of 32 mm was prepared. The shape of the base material 1 was such that one surface (first surface 1A) was a concave spherical surface shape of R 40 mm and the other surface (second surface 1B) was a convex spherical surface shape of R 75 mm. As the mold 4, a mold, in which a NiP layer plated on the metal base material was cut by a precision machine to form an aspherical shape inverted from the aspherical shape of the resin portion 2 that was the molding target, was used.

Next, the resin composition 2a of an ultraviolet curable acrylic resin was filled between the mold 4 and the base material 1. Thereafter, the entire surface of the resin composition 2a was irradiated with ultraviolet light having an intensity of 10 mW/cm² at a wavelength of 365 nm for 200 seconds to cure the resin composition 2a, and the cured product of the resin composition 2a was released from the mold 4 to form the resin portion 2 on the base material 1. The intermediate obtained by releasing the mold was placed in an oven and heated at 80° C. for 24 hours to prepare the optical element 10 of Example 1.

As for the thickness of the resin portion 2 of the optical element 10 obtained, the thickness dc of the resin portion 2 at the lens center P0 was 60 μm, the thickness d1 of the resin portion 2 at the first point P1 was 360 μm, the thickness d2 of the resin portion 2 at the second point P2 was 60 μm, and the thickness d3 of the resin portion 2 at the ridge line portion 1D was 200 μm. The first point P1 was located at 15.8 mm from the center P0. Since the distance from the center P0 to the ridge line 1E was 20 mm, the ratio of the distance P1-P0 from the center P0 to the first point P1 to the distance 1E-P0 from the center P0 to the ridge line 1E was 0.79. The second point P2 was located at 19.8 mm from the center P0. Since the distance from the center P0 to the ridge line 1E was 20 mm, the ratio of the distance P2-P0 from the center P0 to the second point P2 to the distance 1E-P0 from the center P0 to the ridge line 1E was 0.99.

### Example 2

The optical element 10 of Example 2 was fabricated in the same manner as in Example 1 except that the thickness d1 of the resin portion 2 at the first point P1 was 660 μm.

### Example 3

The optical element 10 of Example 3 was fabricated in the same manner as in Example 1 except that the thickness dc of the resin portion 2 at the lens center P0 was 180 μm.

### Example 4

The optical element 10 of Example 4 was fabricated in the same manner as in Example 1 except that the thickness d2 of the resin portion 2 at the second point P2 was 180 μm.

### Example 5

The optical element 10 of Example 5 was fabricated in the same manner as in Example 1 except that the thickness d3 of the resin portion 2 at the ridge line portion 1D was 80 μm.

### Example 6

The optical element 10 of Example 6 was fabricated in the same manner as in Example 1 except that the thickness d1 of the resin portion 2 at the first point P1 was 75 μm.

### Example 7

The optical element 10 of Example 7 was fabricated in the same manner as in Example 1 except that the thickness dc of the resin portion 2 at the lens center P0 was 150 μm, the thickness d1 of the resin portion 2 at the first point P1 was 375 μm, and the thickness d2 of the resin portion 2 at the second point P2 was 150 μm.

### Example 8

The optical element 10 of Example 8 was fabricated in the same manner as Example 1 except that the thickness dc of the resin portion 2 at the lens center P0 was 340 μm and the thickness d1 of the resin portion 2 at the first point P1 was 375 μm.

### Example 9

The optical element 10 of Example 9 was fabricated in the same manner as in Example 1 except that one surface (first surface 1A) of the base material 1 has a convex spherical shape of R 40 mm.

### Comparative Example 1

The optical element of Comparative Example 1 was fabricated in the same manner as in Example 1 except that the thickness d3 of the resin portion 2 at the ridge line portion 1D was 30 μm.

### Comparative Example 2

The optical element of Comparative Example 2 was fabricated in the same manner as in Example 1 except that the thickness d1 of the resin portion 2 at the first point P1 was 30 μm.

### Comparative Example 3

The optical element of Comparative example 3 was fabricated in the same manner as in Example 1 except that the thickness d2 of the resin portion 2 at the second point P2 was 400 μm.

The lens shape and evaluation results of each optical element are summarized in Table 1 shown below. According to Table 1, it can be seen that the optical elements 10 of Examples 1 to 9 are superior to the optical elements of Comparative Examples 1 to 3 in overall evaluation.

TABLE 1

| | | | | | | | | | (Distance between | (Distance between | | | |
|---|---|---|---|---|---|---|---|---|---|---|---|---|---|
| | | | | | | | | | P1 and P0)/ | P2 and P0)/ | Optical | | |
| | | dc | d1 | d2 | d3 | d1/ | d1- | d2/ | (Distance between | (Distance between | Perfor- | Lens | Overall |
| | Lens shape | [μm] | [μm] | [μm] | [μm] | dc | dc | d1 | 1E and P0) | 1E and P0) | mance | Crack | Evaluation |
| Example 1 | concave lens | 60 | 360 | 60 | 200 | 6 | 300 | 0.2 | 0.79 | 0.99 | A | no crack | A |
| Example 2 | concave lens | 60 | 660 | 60 | 200 | 11 | 600 | 0.1 | 0.79 | 0.99 | A | no crack | A |
| Example 3 | concave lens | 180 | 360 | 60 | 200 | 2 | 180 | 0.2 | 0.79 | 0.99 | B | no crack | B |
| Example 4 | concave lens | 60 | 360 | 180 | 200 | 6 | 300 | 0.5 | 0.79 | 0.99 | A | no crack | A |
| Example 5 | concave lens | 60 | 360 | 60 | 80 | 6 | 300 | 0.2 | 0.79 | 0.99 | A | no crack | A |
| Example 6 | concave lens | 60 | 75 | 60 | 200 | 1.3 | 15 | 0.8 | 0.79 | 0.99 | B | no crack | B |
| Example 7 | concave lens | 150 | 375 | 150 | 200 | 2.5 | 225 | 0.4 | 0.79 | 0.99 | A | no crack | A |
| Example 8 | concave lens | 340 | 375 | 60 | 200 | 1.1 | 35 | 0.2 | 0.79 | 0.99 | B | no crack | B |
| Example 9 | convex lens | 60 | 360 | 60 | 200 | 6 | 300 | 0.2 | 0.79 | 0.99 | A | no crack | A |
| Com- | concave lens | 60 | 300 | 60 | 30 | 5 | 240 | 0.2 | 0.79 | 0.99 | A | with | C |
| parative | | | | | | | | | | | | crack | |
| Example 1 | | | | | | | | | | | | | |
| Com- | concave lens | 60 | 30 | 60 | 200 | 0.5 | −30 | 2.0 | 0.79 | 0.99 | C | no crack | C |
| parative | | | | | | | | | | | | | |
| Example 2 | | | | | | | | | | | | | |
| Com- | concave lens | 60 | 300 | 400 | 200 | 5 | 240 | 1.3 | 0.79 | 0.99 | A | with | C |
| parative | | | | | | | | | | | | crack | |
| Example 3 | | | | | | | | | | | | | |

According to the present disclosure, it is possible to provide an optical element having both excellent optical characteristics and excellent environmental durability and a method of manufacturing the optical element.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-019074, filed Feb. 10, 2023, which is hereby incorporated by reference herein in its entirety.

What is claimed is:

1. An optical element comprising:
a base material; and
a resin portion,
wherein the base material has a spherical surface, a flat surface surrounding the spherical surface, and a ridge line portion including a ridge line at the boundary between the spherical surface and the flat surface,
wherein the resin portion
is provided over the spherical surface and over the flat surface of the base material straddling the ridge line portion,
has a linear expansion coefficient different from a linear expansion coefficient of the base material,
has a maximum thickness at a first point between a center and an edge of the spherical surface of the base material, which is thicker than a thickness at the center,
has a thickness thinner than the maximum thickness at a second point between the first point and the edge, and
has a thickness thicker at the ridge line portion than the thickness at the second point.

2. The optical element according to claim 1, wherein the thickness of the resin portion at the first point is three times or more than the thickness of the resin portion at the center.

3. The optical element according to claim 1, wherein the thickness of the resin portion at the center is 300 μm or less.

4. The optical element according to claim 1, wherein the thickness of the resin portion at the first point is thicker than the thickness of the resin portion at the center by 200 μm or more.

5. The optical element according to claim 1, wherein the thickness of the resin portion at the second point is 0.5 times or less than the thickness of the resin portion at the first point.

6. The optical element according to claim 1, wherein the thickness of the resin portion at the ridge line portion is 100 μm or more.

7. The optical element according to claim 1, wherein the flat surface has a surface roughness larger than a surface roughness of the spherical surface.

8. The optical element according to claim 1, wherein the base material is made of glass.

9. The optical element according to claim 1, wherein the spherical surface is a concave spherical surface.

10. The optical element according to claim 1, wherein the base material has a circular planar shape in plan view viewed in a layering direction of the resin portion at the center.

11. The optical element according to claim 1, wherein the flat surface is a plane perpendicular to a layering direction of the resin portion at the center.

12. The optical element according to claim 1, wherein an internal transmittance of the resin portion is at least 70% with respect to a wavelength of 400 nm at a converted thickness of 500 μm.

13. The optical element according to claim 1, wherein a surface of the resin portion has an aspherical shape.

14. The optical element according to claim 1, wherein the resin portion is a cured product of an energy curable composition.

15. The optical element according to claim 1, wherein an Abbe number of the resin portion is 50 or more and less than 60.

16. An optical apparatus comprising a housing and an optical system having at least one lens arranged within the housing,
wherein the at least one lens is the optical element according to claim 1.

17. An imaging apparatus comprising a housing, an optical system having at least one lens arranged within the housing, and an imaging element that receives light that has passed through the optical system,
wherein the at least one lens is the optical element according to claim 1.
